(19) United States
(12) Patent Application Publication
(10) Pub. No.: US 2017/0203247 A1
(43) Pub. Date: Jul. 20, 2017

(54) AXIAL FLOW FILTER

(71) Applicant: Tung-Tsai LEE, Changhua Hsien (TW)

(72) Inventor: Tung-Tsai LEE, Changhua Hsien (TW)

(21) Appl. No.: 14/996,120

(22) Filed: Jan. 14, 2016

(51) Int. Cl. B01D 46/52; B01D 46/00

(52) U.S. Cl. CPC B01D 46/528; B01D 46/0024; B01D 46/0036

(57) ABSTRACT

An axial flow filter contains: a filtration unit. The filtration unit includes at least one filtering material and plural connection materials. Each filtering material spirally rolls outward from its inner end, and said each filtering material has a small-diameter portion formed on the inner end thereof and has a large-diameter portion arranged on an outer end thereof. Between the small-diameter portion and the large-diameter portion defines a height difference, said each filtering material rolls outward to define a gap between any two adjacent filter layers, and a first connection material is fixed between said any two adjacent filter layers and is coated along a middle section of said each filtering material as said each filtering material rolls outward, such that said any two adjacent filter layers of the at least one filtering material are spaced at a fixed distance so as to stop the gap.

### FIELD OF THE INVENTION

The present invention relates to air filtration equipment, and more particularly to an axial flow filter which enhances filtering effect and prolongs its service life.

### BACKGROUND OF THE INVENTION

An air filter is fixed in an internal combustion engine system so as to stop dusts in air flowing into an air cylinder, thus avoiding a damage of the air cylinder. A filter core of the air filter is hollowly cylindrical and contains fiber material rolled on a substrate, such that when air flows into the air filter, the fiber material filters the dusts so as to purify the air.

Because the fiber material is fixed in the air filter and is rolled on the substrate, the air can only flow through the fiber material in a radial flowing manner, hence an air resistance increases and a service life of the air filter reduces to lower power of the internal combustion engine system and to grow oil consumption.

Furthermore, a conventional filter is solely configured in filtration equipment, so an accommodation space of the filtration equipment is limited as desiring to enhance filtering efficiency, i.e., a number of filters cannot be increased based on using requirements.

The present invention has arisen to mitigate and/or obviate the afore-described disadvantages.

### SUMMARY OF THE INVENTION

The primary objective of the present invention is to provide an axial flow filter which contains at least one filtering material rolling together to reduce air resistance and to increase filtering area and cleaning efficiency as being fixed in the filtering cylinder. Preferably, a service life of the axial flow filter is prolonged.

Further objective of the present invention is to provide a filter modularization which contains a plurality of axial flow filters stacked together easily so as to enhance purity effect. Another objective of the present invention is to provide an axial flow filter in which each filtering material of the filtration unit is rolled in any one of a circle shape, a rectangle shape, a rhombus shape, an umbrella shape, an ellipse shape, and a polygon shape so as to satisfy using requirements.

To obtain the above objectives, an axial flow filter provided by a preferred embodiment of the present invention contains a filtration unit.

The filtration unit includes at least one filtering material and plural connection materials, each of the at least one filtering material spirally rolls outward from its inner end, and said each filtering material has a small-diameter portion formed on the inner end thereof and has a large-diameter portion arranged on an outer end thereof, between the small-diameter portion and the large-diameter portion defines a height difference, said each filtering material of the filtration unit rolls outward to define a gap between any two adjacent filter layers, a first connection material is fixed between said any two adjacent filter layers and is coated on and along a middle section of said each filtering material as said each filtering material rolls outward, such that said any two adjacent filter layers of the at least one filtering material are spaced at a fixed distance so as to stop the gap.

An axial flow filter provided by another preferred embodiment of the present invention contains a filtration unit.

The filtration unit includes at least one filtering material and plural connection materials, each of the at least one filtering material spirally rolls outward from its inner end, and said each filtering material has a first close segment defined on an inner end thereof and a second close segment defined on an outer end thereof, said each filtering material of the filtration unit rolls outward to define a gap between any two adjacent filter layers, a first connection material is fixed between said any two adjacent filter layers and is coated on and along a middle section of said each filtering material as said each filtering material rolls outward, such that said any two adjacent filter layers of the at least one filtering material are spaced at a fixed distance so as to stop the gap.

Also, an axial flow filter provided by another preferred embodiment of the present invention contains a filtration unit and a fixer.

The filtration unit includes at least one filtering material, each of the at least one filtering material spirally rolls outward from its inner end, and said each filtering material has a through orifice defined on the inner end thereof.

The fixer inserts into the through orifice of said each filtering material so as to fix the at least one filtering material.

### BRIEF DESCRIPTION OF THE DRAWINGS

FIG. 1 is a perspective view showing the assembly of an axial flow filter according to a first embodiment of the present invention.

FIG. 2 is a top plan view showing the assembly of the axial flow filter according to the first embodiment of the present invention.

FIG. 3 is a cross sectional view showing the assembly of a part of the axial flow filter according to the first embodiment of the present invention.

FIG. 4 is a cross sectional view showing the assembly of an axial flow filter according to a second embodiment of the present invention.

FIG. 5 is a perspective view showing the assembly of an axial flow filter according to a third embodiment of the present invention.

FIG. 6 is a perspective view showing the exploded components of the axial flow filter according to the third embodiment of the present invention.

FIG. 7 is a cross sectional view showing the assembly of the axial flow filter according to the third embodiment of the present invention.

FIG. 8 is a perspective view showing the exploded components of an axial flow filter according to a fourth embodiment of the present invention.

FIG. 9 is a cross sectional view showing the assembly of the axial flow filter according to the fourth embodiment of the present invention.

FIG. 10 is a cross sectional view showing the application of the axial flow filter according to the fourth embodiment of the present invention.

FIG. 11 is a cross sectional view showing a plurality of axial flow filters being stacked together according to a fifth embodiment of the present invention.

FIG. 12 is a perspective view showing the exploded components of an axial flow filter according to a sixth embodiment of the present invention.

FIG. 13 is a cross sectional view showing the assembly of the axial flow filter according to the sixth embodiment of the present invention.

FIG. 14 is a perspective view showing a plurality of filtering materials being stacked and rolled together according to the present invention.

FIG. 15 is a perspective view showing an outer filtrating layer and an inner filtrating layer being rolled together according to the present invention.

FIG. 16 is a cross sectional view showing the assembly of an axial flow filter according to a seventh embodiment of the present invention.

FIG. 17 is a cross sectional view showing the assembly of an axial flow filter according to an eighth embodiment of the present invention.

FIG. 18 is a cross sectional view showing the assembly of an axial flow filter according to a ninth embodiment of the present invention.

FIG. 19 is a cross sectional view showing the assembly of an axial flow filter according to a tenth embodiment of the present invention.

### DETAILED DESCRIPTION OF THE PREFERRED EMBODIMENTS

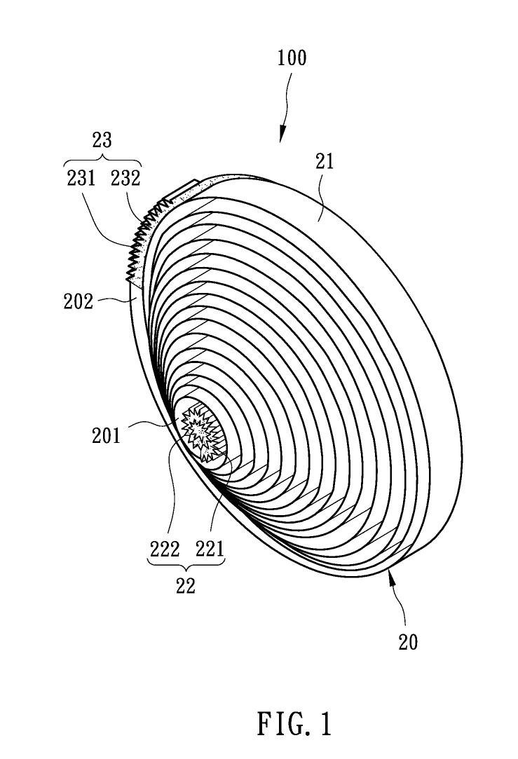

With reference to FIGS. 1 to 3, an axial flow filter 100 according to a first embodiment of the present invention comprises a filtration unit 20.

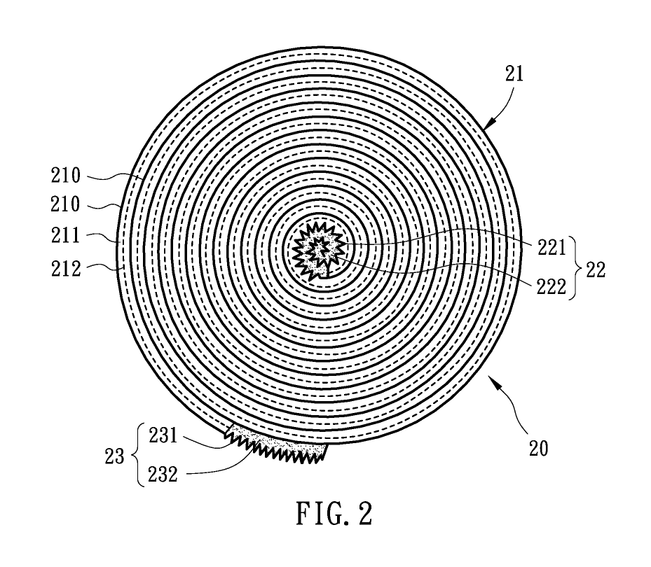

The filtration unit 20 includes at least one filtering material 21 and plural connection materials 212, 222, and 232, each of the at least one filtering material 21 spirally rolls outward from its inner end, and said each filtering material 21 has a small-diameter portion 201 formed on the inner end thereof and has a large-diameter portion 202 arranged on an outer end thereof, wherein between the small-diameter portion 201 and the large-diameter portion 202 defines a height difference H. Said each filtering material 21 of the filtration unit 20 rolls outward to define a gap 211 between any two adjacent filter layers 210. The first connection material 212 is fixed between said any two adjacent filter layers 210 and is coated on and along a middle section of said each filtering material 21 as said each filtering material 21 rolls outward, such that said any two adjacent filter layers 210 of the at least one filtering material 21 are spaced at a fixed distance (the first connection material 212 is denoted by a dotted line as shown in FIG. 2) so as to stop the gap 211, thus avoiding a leakage of filtered object from the gap 211. The small-diameter portion 201 of said each filtering material 21 has a first wrinkle portion 221, and between the first wrinkle portion 221 and said each filtering material 21 is filled a second connection material 222, the large-diameter portion 202 has a second wrinkle portion 231, and between the second wrinkle portion 231 and said each filtering material 21 is filled a third connection material 232, wherein each of the first connection material 212, the second connection material 222, and the third connection material 232 is a hot-melt glue.

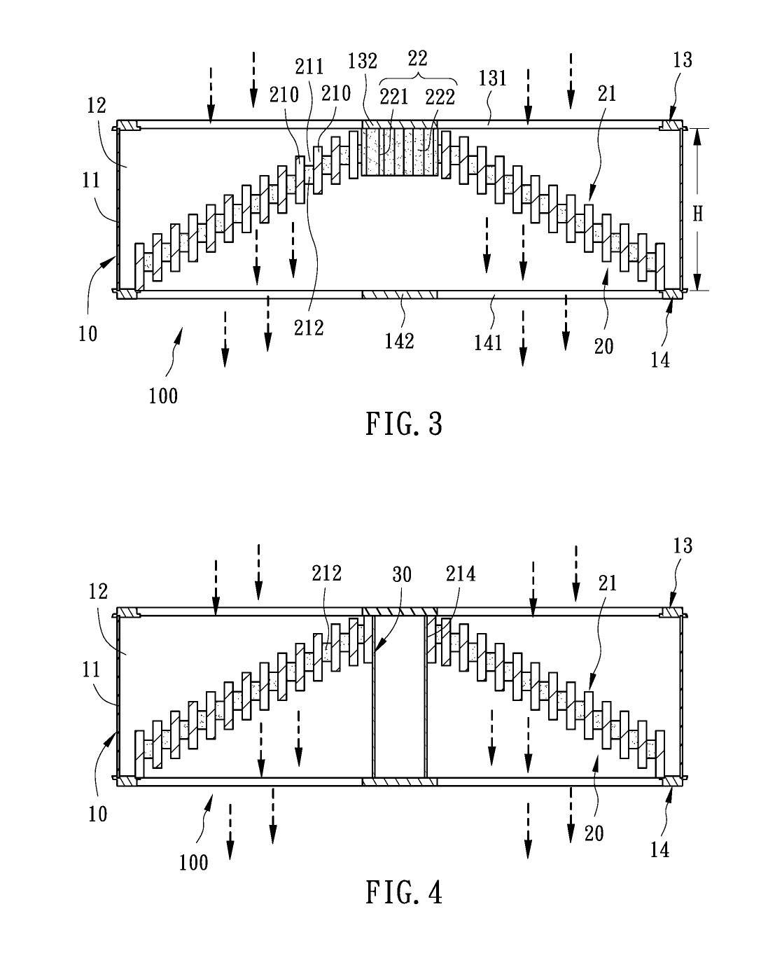

The filtration unit 20 of the axial flow filter 100 is accommodated in a casing unit 10, as shown in FIG. 3.

The casing unit 10 includes a body 11, a chamber 12 defined in the body 11, a first cover 13, and a second cover 14, wherein the first cover 13 has a first opening 131 and a plurality of first ribs 132 radially arranged on the first opening 131, the second cover 14 has a second opening 141 and a plurality of second ribs 142 radially arranged on the second opening 141. In this embodiment, the plurality of first ribs 132 and the plurality of second ribs 142 are radially arranged so that plural sector areas are defined in the first opening 131 and the second opening 141.

In operation, the said each filtering material 21 is housed in the chamber 12 of the casing unit 10, the filtered object is filtered by said each filtering material 21 after flowing into the first opening 131 of the casing unit 10, and the filtered object flows out of the second opening 141.

Said each filtering material 21 is any one of metal wire, fiber mesh, activated carbon cloth, nonwoven fabric, and glass fiber so as to filter oils, mist, smokes, and hazes. Preferably, the metal wire is made of stainless steel.

Referring to FIG. 4, an axial flow filter 100 according to a second embodiment of the present invention comprises: a casing unit 10, a filtration unit 20, and a fixer 30.

The filtration unit 20 includes at least one filtering material 21 and plural connection materials 212, the at least one filtering material 21 spirally rolls outward, and said each filtering material 21 has a through orifice 214 defined on an inner end thereof.

The fixer 30 inserts into the through orifice 214 of said each filtering material 21 so as to fix the at least one filtering material 21, wherein the at least one filtering material 21 and the fixer 30 are housed in the chamber 12 of the casing unit 10 and are limited by the first cover 13 and the second cover 14 to position in the casing unit 10.

Accordingly, the fixer 30 fixes the at least one filtering material 21 in the body 11 of the casing unit 10.

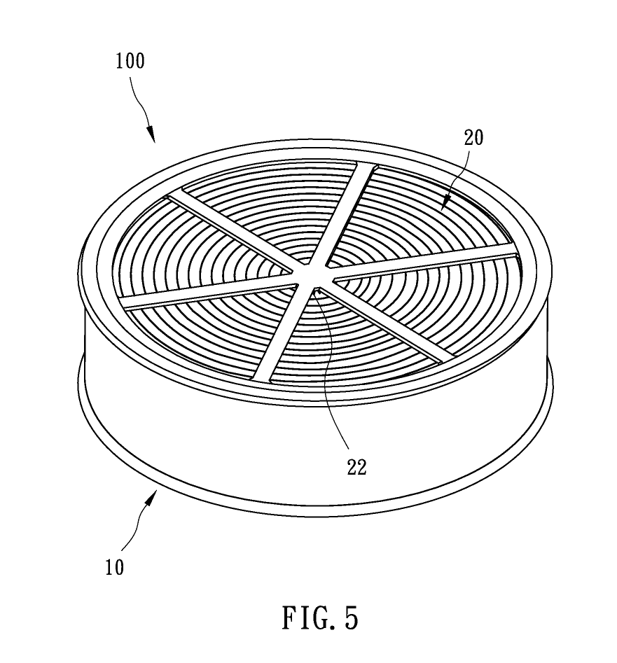

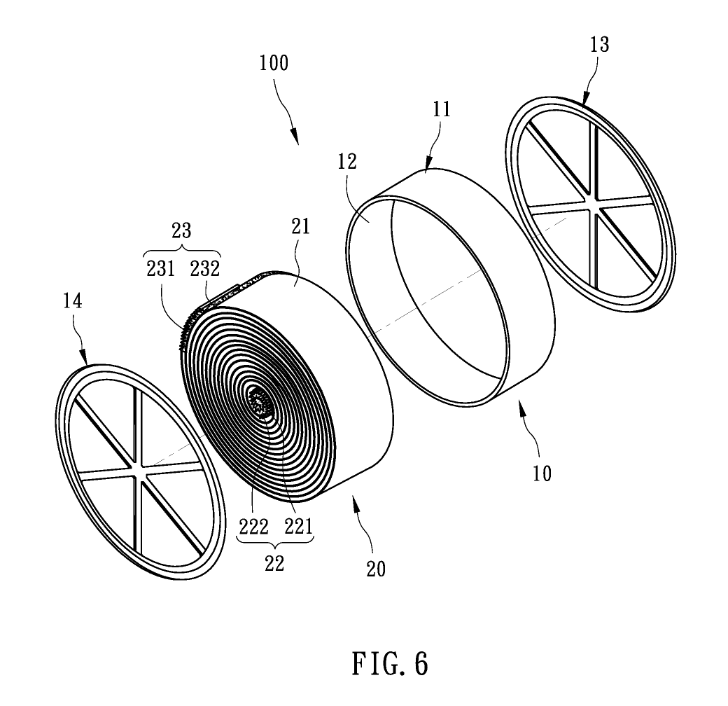

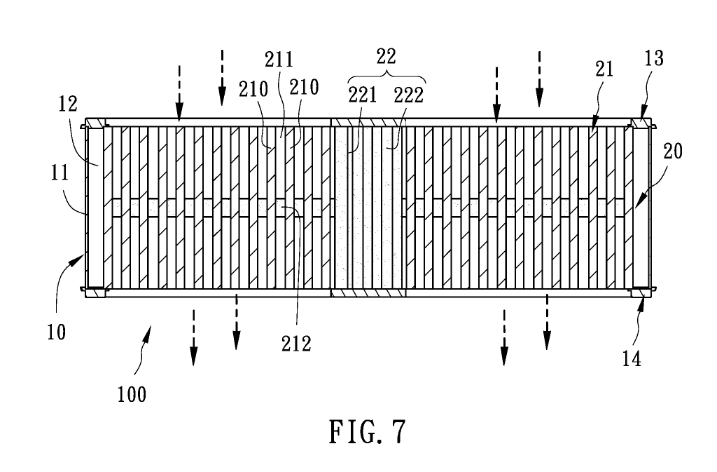

As shown in FIGS. 5 to 7, an axial flow filter 100 according to a third embodiment of the present invention comprises: a casing unit 10 and a filtration unit 20.

The casing unit 10 includes a body 11, a chamber 12, a first cover 13, and a second cover 14.

The filtration unit 20 includes at least one filtering material 21, and each filtering material 21 spirally rolls outward, wherein said each filtering material 21 has a first close segment 22 defined on an inner end thereof and a second close segment 23 defined on an outer end thereof, and the first close segment 22 has a first wrinkle portion 221 adhered with said each filtering material 21 by using a second connection material 222, the second close segment 23 has a second wrinkle portion 231 adhered with said each filtering material 21 by using a third connection material 232, and each of plural filter layers 210 is adhered by way of a first connection material 212 so as to stop each of a plurality of gaps 211. It is to be noted that the first close segment 22 and the second close segment 23 are in a same horizontal position, i.e., no height difference occurs between the first close segment 22 and the second close segment 23.

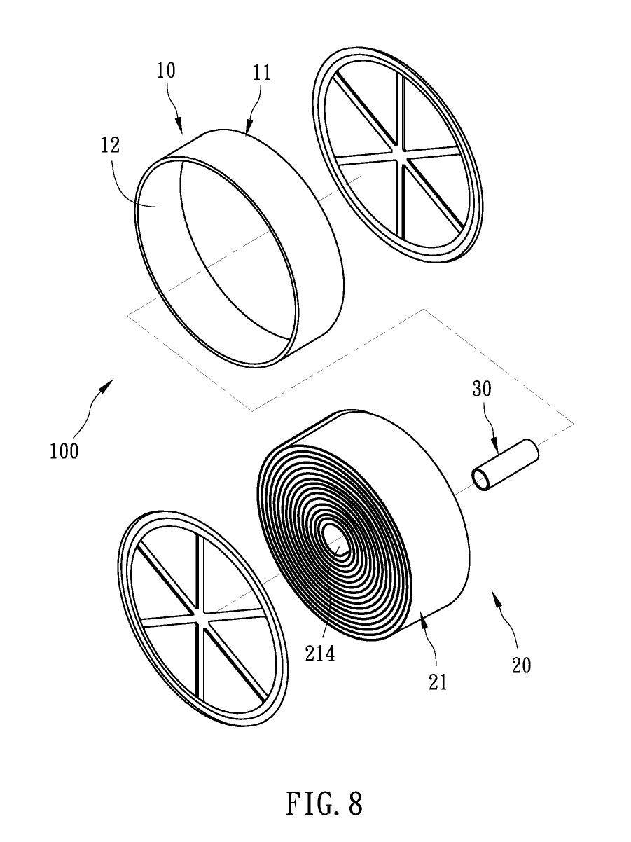

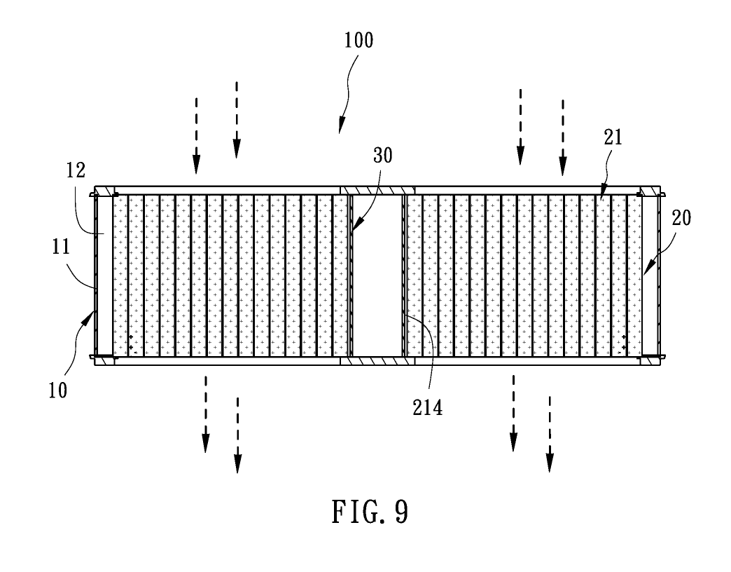

As illustrated in FIGS. 8 and 9, a difference of an axial flow filter 100 of a fourth embodiment of the present invention from that of the third embodiment comprises: a fixer 30.

A filtration unit 20 includes at least one filtering material 21, and each of the at least one filtering material 21 has a through orifice 214 defined on an inner end thereof.

The fixer 30 inserts into the through orifice 214 of said each filtering material 21 so as to fix the at least one filtering material 21, wherein said each filtering material 21 and the fixer 30 are housed in a chamber 12 of a casing unit 10. Accordingly, the fixer 30 is configured to fix the at least one filtering material 21 in a body 11 of the casing unit 10.

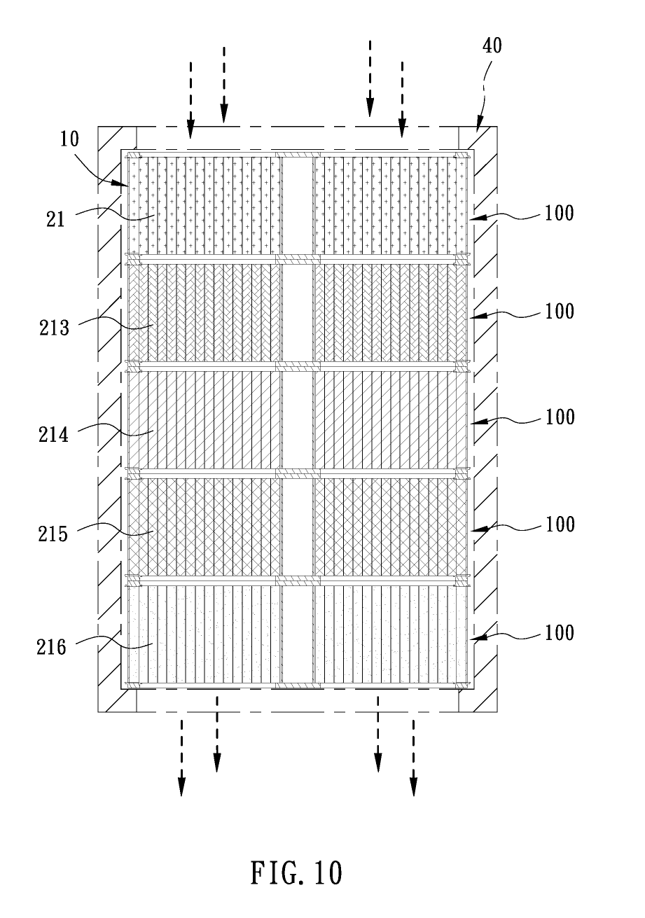

With reference to FIG. 10, a plurality of axial flow filters 100 are stacked in a filtering cylinder 40, and each of the plurality of axial flow filters 100 has one of plural filtering materials 21, 213, 214, 215, and 216, wherein each of the plural filtering materials 21, 213, 214, 215, and 216 is any one of metal wire, fiber mesh, activated carbon cloth, nonwoven fabric, and glass fiber so as to enhance filtering effect of said each filtering material 100.

Referring to FIG. 11, a filter modularization according to a fifth embodiment of the present invention comprises a plurality of axial flow filters 100 which are stacked together, and each axial flow filter 100 comprises: a casing unit 10, a filtration unit 20, and a fixer 30. A difference of said each axial flow filter 100 of this fifth embodiment from that of the second embodiment comprises: the fixer 30 including an insertion portion 31 arranged on a first end thereof, and the fixer 30 also including a coupling portion 32 defined on a second end thereof; a first cover 13 including a first aperture 133 formed on a central position thereof; and a second cover 14 including a second aperture 143 formed on a central position of thereof. In assembly, the insertion portion 31 of the fixer 30 is inserted into the first aperture 133 of the first cover 13, and the coupling portion 32 of the fixer 30 is inserted into the second aperture 143 of the second cover 14. Thereby, the plurality of axial flow filters 100 are fixed and stacked together by way of the insertion portion 31 and the coupling portion 32 of the fixer 30. Preferably, each axial flow filter 100 has the one of the plural filtering materials 21, 213, 214, and 215, wherein each filtering material 21, 213, 214, and 215 is any one of metal wire, fiber mesh, activated carbon cloth, nonwoven fabric, and glass fiber so as to enhance filtering effect of said each filtering material. Preferably, the plurality of axial flow filters 100 are fixed by way of the fixer 30 without using the filtering cylinder of FIG. 10.

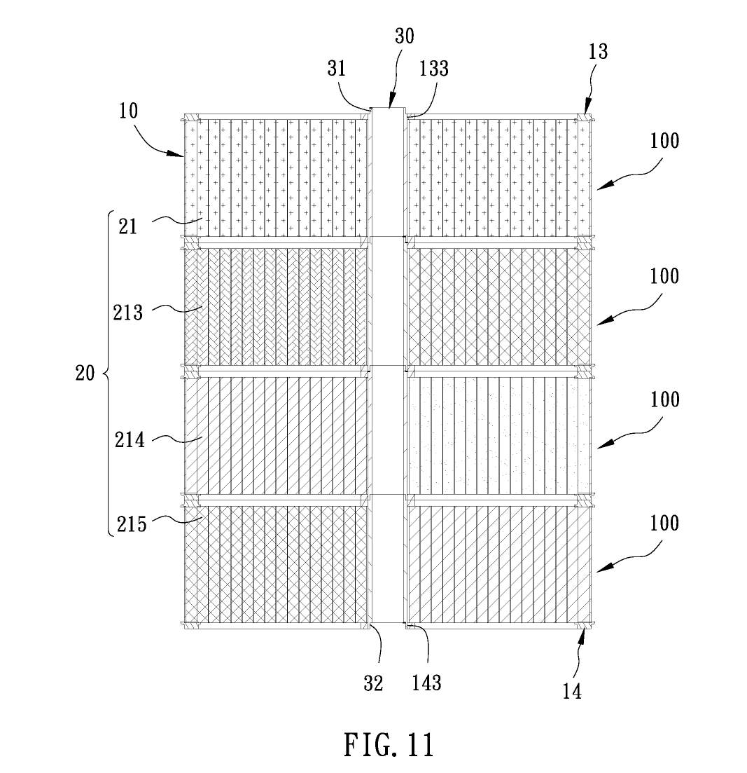

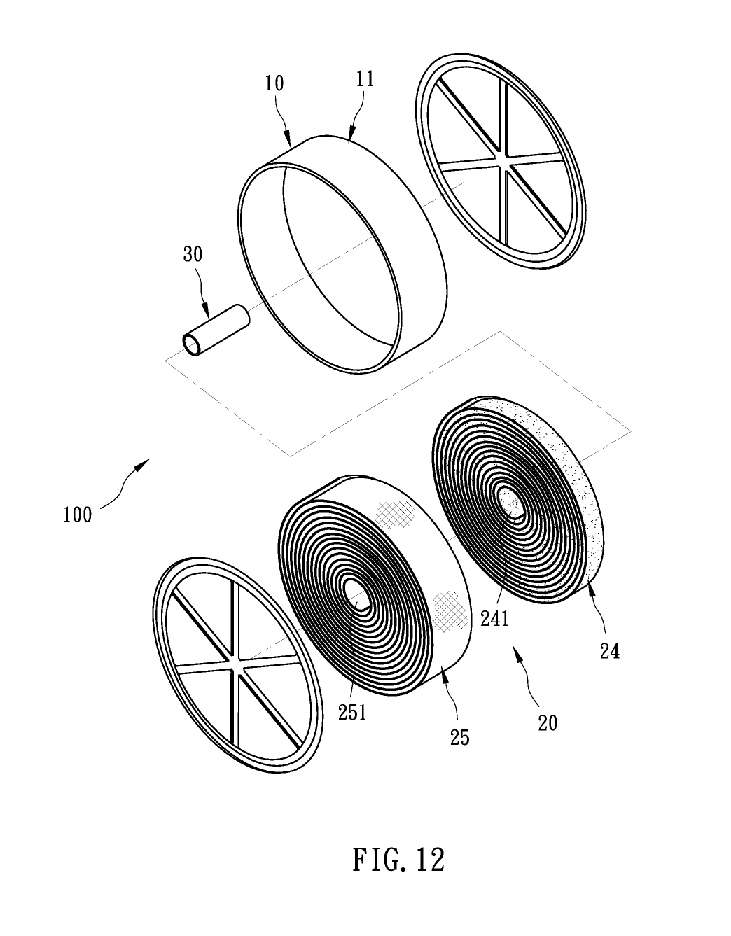

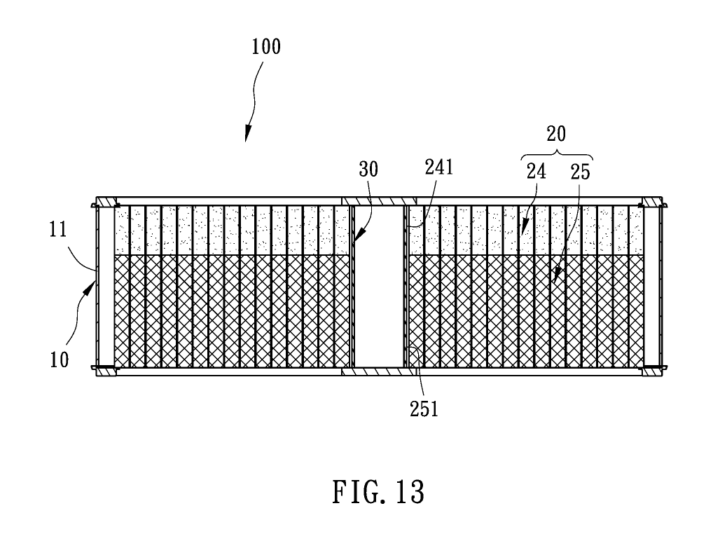

As shown in FIGS. 12 and 13, an axial flow filter 100 according to a sixth embodiment of the present invention comprises: a casing unit 10, a filtration unit 20, and a fixer 30.

The casing unit 10 and the fixer 30 are identical to those of FIG. 5, so further remarks are omitted.

The filtration unit 20 includes a first filtering material 24 and a second filtering material 25, wherein each of the first filtering material 24 and the second filtering material 25 spirally rolls outward from its inner end, wherein the first filtering material 24 has a first through orifice 241 defined on an inner end thereof, and the second filtering material 25 has a second through orifice 251 defined on an inner end thereof, hence the fixer 30 inserts into the first through orifice 241 and the second through orifice 251.

A difference of the axial flow filter 100 of this sixth embodiment from that of the fourth embodiment comprises the first filtering material 24 and the second filtering material 25 which are housed in a body 11 of the casing unit 10, such that the axial flow filter 100 filters oils, mist, smokes, and hazes by means of the first filtering material 24 and the second filtering material 25. The first filtering material 24 and the second filtering material 25 are any two of metal wire, fiber mesh, activated carbon cloth, nonwoven fabric, and glass fiber so as to enhance filtering effect.

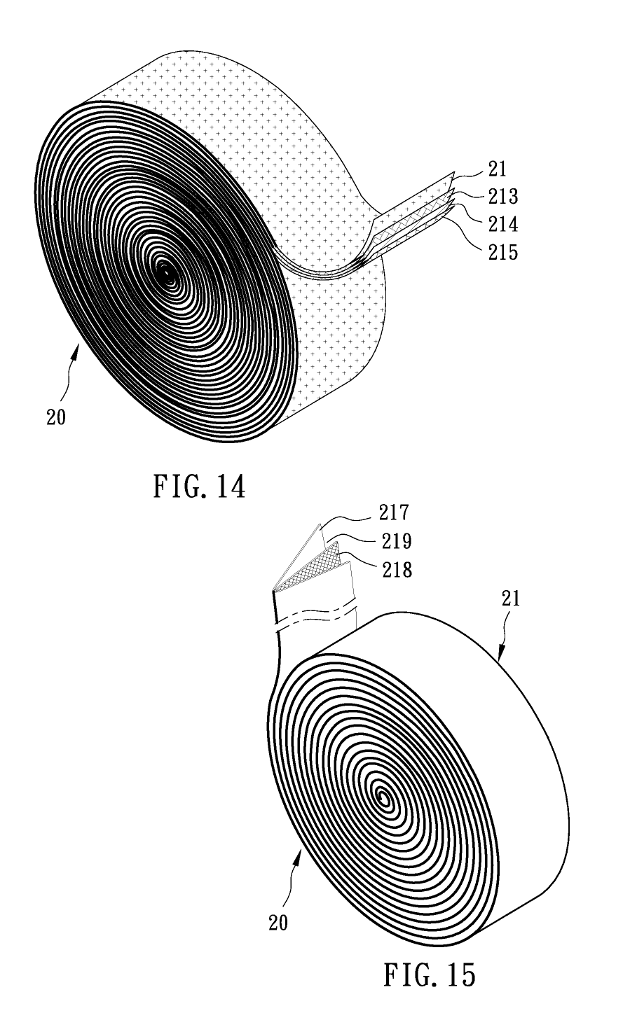

With reference to FIG. 14, a filtration unit 20 includes a plurality of filtering materials 21, 213, 214, and 215 which are stacked and rolled together. Referring to FIG. 15, a faltering material 21 of a filtration unit 20 has an outer filtrating layer 217 and an inner filtrating layer 218 which are rolled together, wherein the outer filtrating layer 217 is folded in half so as to form an accommodation space 219 for accommodating the inner filtrating layer 218.

As shown in FIGS.1 to 15, the casing unit 10 and the filtration unit 20 are circular.

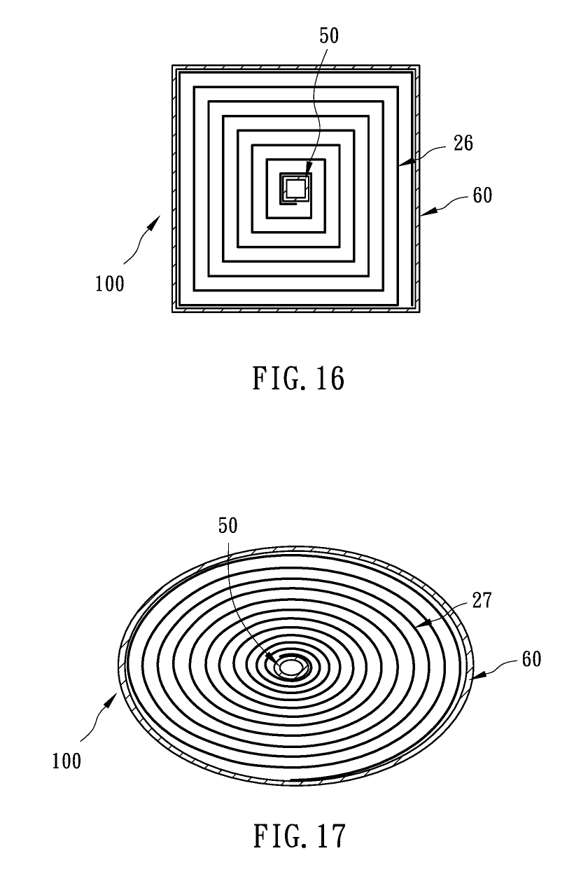

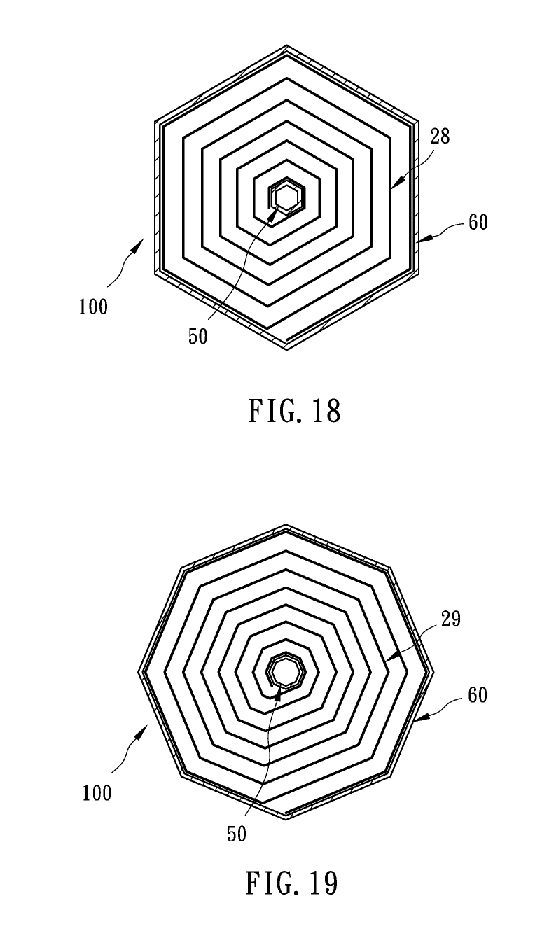

Said each filtering material is rolled in a rhombus shape or an umbrella shape. As illustrated in FIG. 16, in a seventh embodiment, a filtering material 26 of an axial flow filter 100 is rolled in a rectangle shape. With reference to FIG. 17, in an eighth embodiment, a filtering material 27 of an axial flow filter 100 is rolled in an ellipse shape. Referring to FIG. 18, in a ninth embodiment, a filtering material 28 of an axial flow filter 100 is rolled in a polygon shape, such as a hexagon shape. As shown in FIG. 19, in a tenth embodiment, a filtering material 29 of an axial flow filter 100 is rolled in a polygon shape, such as an octagon shape, and a fixer 50 and a casing unit 60 are configured to fix each of the filtering materials 26, 27, 28, and 19. Preferably, a profile of each of the fixer 50 and the casing unit 60 corresponds to said each filtering material 26, 27, 28, and 19.

As rolling said each filtering material 21 of FIGS. 8 to 19, the at least one connection material is configured to adhere said each filter layer and to stop said each gap 211, as illustrated in FIG. 3.

Thereby, the axial flow filter 100 reduces air resistance and increases filtering area and cleaning efficiency as being fixed in the filtering cylinder 40. Preferably, a service life of the axial flow filter 100 is prolonged.

With reference to FIGS. 1 to 13, the filter modularization comprises the plurality of axial flow filters 100 which are stacked in the filtering cylinder 40 to enhance filtering effect. Referring to FIG. 11, the plurality of axial flow filters 100 are fixed by way of the fixer 30 without using the filtering cylinder 40 of FIG. 10.

With reference to FIG. 14, the filtration unit includes the plurality of filtering materials stacked and rolled together. Referring to FIG. 15, the faltering material of the filtration unit has the outer filtrating layer and the inner filtrating layer which are rolled together so as to increase filtering effect, such as filtering the oils. As illustrated in FIGS. 16 to 19, the axial flow filter 100 is formed in rectangle, ellipse, hexagon or octagon shape to satisfy using requirements.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. An axial flow filter comprising:
a filtration unit including at least one filtering material and plural connection materials, each of the at least one filtering material spirally rolling outward from its inner end, and said each filtering material having a small-diameter portion formed on the inner end thereof and having a large-diameter portion arranged on an outer end thereof, between the small-diameter portion and the large-diameter portion defining a height difference, said each filtering material of the filtration unit rolling outward to define a gap between any two adjacent filter layers, a first connection material being fixed between said any two adjacent filter layers and being coated on and along a middle section of said each filtering material as said each filtering material rolls outward, such that said any two adjacent filter layers of the at least one filtering material are spaced at a fixed distance so as to stop the gap.

2. The axial flow filter as claimed in claim 1, wherein the small-diameter portion of said each filtering material has a first wrinkle portion, and between the first wrinkle portion and said each filtering material is filled a second connection material, the large-diameter portion has a second wrinkle portion, and between the second wrinkle portion and said each filtering material is filled a third connection material.

3. The axial flow filter as claimed in claim 1, wherein said each filtering material is any one of metal wire, fiber mesh, activated carbon cloth, nonwoven fabric, and glass fiber.

4. The axial flow filter as claimed in claim 1 further comprising a casing unit configured to accommodate the filtration unit and including a body, a chamber defined in the body, a first cover, and a second cover, wherein the first cover has a first opening and a plurality of first ribs radially arranged on the first opening, and the second cover has a second opening and a plurality of second ribs radially arranged on the second opening.

5. The axial flow filter as claimed in claim 1 further comprising a fixer and a through orifice defined on an inner end of said each filtering material, wherein the fixer inserts into the through orifice of said each filtering material so as to fix the at least one filtering material.

6. An axial flow filter comprising:
a filtration unit including at least one filtering material and at least one connection materials, each of the at least one filtering material spirally rolling outward from its inner end, and said each filtering material having a first close segment defined on an inner end thereof and a second close segment defined on an outer end thereof, said each filtering material of the filtration unit rolling outward to define a gap between any two adjacent filter layers, a first connection material being fixed between said any two adjacent filter layers and being coated on and along a middle section of said each filtering material as said each filtering material rolls outward, such that said any two adjacent filter layers of the at least one filtering material are spaced at a fixed distance so as to stop the gap.

7. The positioning structure for the worm wheel as claimed in claim 6, wherein the first close segment of said each filtering material has a first wrinkle portion, and between the first wrinkle portion and said each filtering material is filled a second connection material, the second close segment has a second wrinkle portion, and between the second wrinkle portion and said each filtering material is filled a third connection material.

8. The axial flow filter as claimed in claim 6, wherein said each filtering material is any one of metal wire, fiber mesh, activated carbon cloth, nonwoven fabric, and glass fiber.

9. The positioning structure for the worm wheel as claimed in claim 6 further comprising a casing unit configured to accommodate the filtration unit and including a body, a chamber defined in the body, a first cover, and a second cover, wherein the first cover has a first opening and a plurality of first ribs radially arranged on the first opening, and the second cover has a second opening and a plurality of second ribs radially arranged on the second opening.

10. An axial flow filter comprising:
a filtration unit including at least one filtering material, each of the at least one filtering material spirally rolling outward from its inner end, and said each filtering material having a through orifice defined on the inner end thereof; and
a fixer inserting into the through orifice of said each filtering material so as to fix the at least one filtering material.

11. The axial flow filter as claimed in claim 10 further comprising a casing unit configured to accommodate the filtration unit and the fixer, and the casing unit including a body, a chamber defined in the body, a first cover, and a second cover, wherein the first cover has a first opening and a plurality of first ribs radially arranged on the first opening, and the second cover has a second opening and a plurality of second ribs radially arranged on the second opening.

12. The axial flow filter as claimed in claim 11, wherein the first cover includes a first aperture formed on a central position thereof, and the second cover includes a second aperture formed on a central position of thereof; the fixer includes an insertion portion arranged on a first end thereof, and the fixer also includes a coupling portion defined on a second end thereof, the insertion portion of the fixer is inserted into the first aperture of the first cover, and the coupling portion of the fixer is inserted into the second aperture of the second cover.

13. The axial flow filter as claimed in claim 12, wherein a plurality of axial flow filters are fixed and stacked together by way of the insertion portion and the coupling portion of the fixer.

14. The axial flow filter as claimed in claim 10, wherein said each filtering material is any one of metal wire, fiber mesh, activated carbon cloth, nonwoven fabric, and glass fiber.

15. The axial flow filter as claimed in claim 10, wherein the filtration unit includes a plurality of filtering materials which are stacked and rolled together.

16. The axial flow filter as claimed in claim 10, wherein said each faltering material of the filtration unit has an outer filtrating layer and an inner filtrating layer which are rolled together, wherein the outer filtrating layer is folded in half so as to form an accommodation space for accommodating the inner filtrating layer.

17. The axial flow filter as claimed in claim 10, wherein said each filtering material of the filtration unit is rolled in any one of a circle shape, a rectangle shape, a rhombus shape, an umbrella shape, an ellipse shape, and a polygon shape, wherein a profile of the fixer corresponds to said each filtering material.

18. The axial flow filter as claimed in claim 17 further a casing unit configured to accommodate said each filtering material and the fixer, wherein a profile of the casing unit corresponds to said each filtering material.
